(19) United States
(12) Patent Application Publication
(10) Pub. No.: US 2026/0141767 A1
(43) Pub. Date: May 21, 2026

(54) INFRASTRUCTURE ACCESS CONTROL USING VEHICLE-BASED LIDAR

(71) Applicant: GM GLOBAL TECHNOLOGY OPERATIONS LLC, DETROIT, MI (US)

(72) Inventors: Sai Vishnu Aluru, Commerce Twp., MI (US); Alison Bayzat, South Lyon, MI (US); Nadia Abousaleh, Dearborn, MI (US)

(21) Appl. No.: 18/951,842

(22) Filed: Nov. 19, 2024

(51) Int. Cl. G07C 9/10; B60W 60/00; G01S 17/89; G01S 17/931

(52) U.S. Cl. CPC G07C 9/10; B60W 60/001; G01S 17/89; G01S 17/931; B60W 2420/403; B60W 2420/408; B60W 2552/50; B60W 2556/50

(57) ABSTRACT

Examples described herein provide a method for infrastructure access control using vehicle-based lidar. The method includes detecting an infrastructure object in an environment in which a vehicle is operating based at least in part on lidar data collected by a lidar device of the vehicle. The method further includes emitting a custom lidar scan pattern associated with the infrastructure object, the custom lidar scan pattern being received by a receiver of the infrastructure object and causing the infrastructure object to implement an action. The method further includes, responsive to the infrastructure object implementing the action, autonomously controlling the vehicle to cause the vehicle to navigate with respect to the infrastructure object.

### BACKGROUND

The subject disclosure relates to vehicles, and in particular to infrastructure access control using vehicle-based lidar.

Modern vehicles (e.g., a car, a motorcycle, a boat, or any other type of automobile) may be equipped with one or more cameras that provide back-up assistance, take images of the vehicle driver to determine driver drowsiness or attentiveness, provide images of the road as the vehicle is traveling for collision avoidance purposes, provide structure recognition (e.g., roadway signs, etc.), and/or the like, including combinations and/or multiples thereof. For example, a vehicle can be equipped with multiple cameras, and images from multiple cameras (referred to as “surround view cameras”) can be used to create a “surround” or “bird's eye” view of the vehicle. Some of the cameras (referred to as “long-range cameras”) can be used to capture long-range images (e.g., for object detection for collision avoidance, structure recognition, etc.).

Such vehicles can also be equipped with sensors such as a radar device(s), lidar device(s), and/or the like for perception tasks. Lidar (light detection and ranging) involves using light (e.g., a pulsed laser) to measure distance to objects by emitting laser pulses, detecting a reflection (e.g., off of an object) of the emitted laser pulse, and measuring the time between the emission and the detection. The measured time can be used to determine the distance between the lidar device and the detected object. Perception tasks can include one or more of object detection, classification, tracking, lane detection, road sign recognition, and obstacle avoidance. Perception tasks are particularly useful for an autonomous vehicle to provide the autonomous vehicle with real-time awareness of its environment to make safe and informed driving decisions. Images from the one or more cameras of the vehicle can also be used for detecting objects, tracking targets, and/or the like, including combinations and/or multiples thereof.

### SUMMARY

In one embodiment, a computer-implemented method for infrastructure access control using vehicle-based lidar is provided. The method includes detecting an infrastructure object in an environment in which a vehicle is operating based at least in part on lidar data collected by a lidar device of the vehicle. The method further includes emitting a custom lidar scan pattern associated with the infrastructure object, the custom lidar scan pattern being received by a receiver of the infrastructure object and causing the infrastructure object to implement an action. The method further includes, responsive to the infrastructure object implementing the action, autonomously controlling the vehicle to cause the vehicle to navigate with respect to the infrastructure object.

In addition to one or more of the features described herein, or as an alternative, further embodiments of the method may include that the infrastructure object is an access gate, and wherein the action is opening the access gate.

In addition to one or more of the features described herein, or as an alternative, further embodiments of the method may include, subsequent to emitting the custom lidar scan pattern associated with the infrastructure object and prior to autonomously controlling the vehicle, determining whether the infrastructure object implemented the action successfully.

In addition to one or more of the features described herein, or as an alternative, further embodiments of the method may include that autonomously controlling the vehicle is performed responsive to determining that the infrastructure object implemented the action successfully.

In addition to one or more of the features described herein, or as an alternative, further embodiments of the method may include, responsive to determining that the infrastructure object failed to implement the action successfully, initiating a remote system to acquire an image of the infrastructure object while the custom lidar scan pattern is emitted, receiving the image of the infrastructure object from the remote system, verifying a luminance change in the image of the infrastructure object matches an expected luminance change based on the custom lidar scan pattern with the infrastructure object, and responsive to verifying that the luminance change in the image of the infrastructure object matches the expected luminance change, causing, by the remote system, the infrastructure object to implement the action.

In addition to one or more of the features described herein, or as an alternative, further embodiments of the method may include that emitting the custom lidar scan pattern associated with the infrastructure object includes: acquiring, by the lidar device, a point cloud of the infrastructure object, using a standard lidar scan pattern, normalizing the standard lidar scan pattern based on a location of the vehicle relative to a location of the infrastructure object, selecting the custom lidar scan pattern from a plurality of custom lidar scan patterns based on the infrastructure object, and causing the lidar device to emit the custom lidar scan pattern.

In addition to one or more of the features described herein, or as an alternative, further embodiments of the method may include that the custom lidar scan pattern causes the infrastructure object to implement the action responsive to the custom lidar scan pattern matching an expected custom lidar scan pattern.

In addition to one or more of the features described herein, or as an alternative, further embodiments of the method may include that the custom lidar scan pattern is defined by a custom frequency.

In addition to one or more of the features described herein, or as an alternative, further embodiments of the method may include that the custom lidar scan pattern is defined by a custom sequence of lidar pulses.

In another embodiment, a vehicle is provided. The vehicle includes a driver monitoring system having a camera. The vehicle further includes a lidar device and a processing system for infrastructure access control using vehicle-based lidar. The processing system includes a memory having computer readable instructions and a processing device for executing the computer readable instructions, the computer readable instructions controlling the processing system to perform operations. The operations include detecting an infrastructure object in an environment in which the vehicle is operating based at least in part on lidar data collected by the lidar device of the vehicle. The operations further include determining, using an image of an operator of the vehicle captured by the camera, whether the operator of the vehicle is an authorized operator of the vehicle. The operations further include, responsive to determining that the operator of the vehicle is the authorized operator of the vehicle, emitting a custom lidar scan pattern associated with the infrastructure object, the custom lidar scan pattern being received by a receiver of the infrastructure object and causing the infrastructure object to implement an action. The operations further include, responsive to the infrastructure object implementing the action, autonomously controlling the vehicle to cause the vehicle to navigate with respect to the infrastructure object.

In addition to one or more of the features described herein, or as an alternative, further embodiments of the vehicle may include that the camera a first camera, the vehicle further comprising a second camera.

In addition to one or more of the features described herein, or as an alternative, further embodiments of the vehicle may include a global positioning system (GPS) device, the operations further comprising determining a location of the infrastructure object based at least in part on information received from the GPS device.

In addition to one or more of the features described herein, or as an alternative, further embodiments of the vehicle may include that the custom lidar scan pattern associated with the infrastructure object is emitted based at least in part on the location of the infrastructure object.

In addition to one or more of the features described herein, or as an alternative, further embodiments of the vehicle may include that the operations further include, responsive to determining that the operator of the vehicle is not the authorized operator of the vehicle, generating an alert.

In addition to one or more of the features described herein, or as an alternative, further embodiments of the vehicle may include that emitting the custom lidar scan pattern associated with the infrastructure object includes: acquiring, by the lidar device, a point cloud of the infrastructure object, using a standard lidar scan pattern, normalizing the standard lidar scan pattern based on a location of the vehicle relative to a location of the infrastructure object, selecting the custom lidar scan pattern from a plurality of custom lidar scan patterns based on the infrastructure object, and causing the lidar device to emit the custom lidar scan pattern.

In addition to one or more of the features described herein, or as an alternative, further embodiments of the vehicle may include that the operations further include, subsequent to emitting the custom lidar scan pattern associated with the infrastructure object and prior to autonomously controlling the vehicle, determining whether the infrastructure object implemented the action successfully.

In addition to one or more of the features described herein, or as an alternative, further embodiments of the vehicle may include that autonomously controlling the vehicle is performed responsive to determining that the infrastructure object implemented the action successfully.

In addition to one or more of the features described herein, or as an alternative, further embodiments of the vehicle may include that the operations further include, responsive to determining that the infrastructure object failed to implement the action successfully, initiating a remote system to acquire an image of the infrastructure object while the custom lidar scan pattern is emitted, receiving the image of the infrastructure object from the remote system, verifying a luminance change in the image of the infrastructure object matches an expected luminance change based on the custom lidar scan pattern with the infrastructure object, and responsive to verifying that the luminance change in the image of the infrastructure object matches the expected luminance change, causing, by the remote system, the infrastructure object to implement the action.

In another embodiment a computer program product is provided. The computer program product includes a set of one or more computer-readable storage media and program instructions, collectively stored in the set of one or more storage media, for causing a processor set to perform computer operations for infrastructure access control using vehicle-based lidar. The computer operations include detecting an infrastructure object in an environment in which a vehicle is operating based at least in part on lidar data collected by a lidar device of the vehicle. The operations further include emitting a custom lidar scan pattern associated with the infrastructure object, the custom lidar scan pattern being received by a receiver of the infrastructure object and causing the infrastructure object to implement an action. The operations further include, responsive to the infrastructure object implementing the action, autonomously controlling the vehicle to cause the vehicle to navigate with respect to the infrastructure object.

In addition to one or more of the features described herein, or as an alternative, further embodiments of the computer program product may include that emitting the custom lidar scan pattern associated with the infrastructure object includes: acquiring, by the lidar device, a point cloud of the infrastructure object, using a standard lidar scan pattern, normalizing the standard lidar scan pattern based on a location of the vehicle relative to a location of the infrastructure object, selecting the custom lidar scan pattern from a plurality of custom lidar scan patterns based on the infrastructure object, and causing the lidar device to emit the custom lidar scan pattern.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates a vehicle with a processing system and sensors according to one or more embodiments;

FIG. 2 illustrates the processing system of FIG. 1 according to one or more embodiments;

FIG. 3 illustrates a flow diagram of a method for infrastructure access control using vehicle-based lidar according to one or more embodiments;

FIG. 4 illustrates a flow diagram of a method for infrastructure access control using vehicle-based lidar according to one or more embodiments;

FIG. 5A depicts a block diagram of a standard lidar scan pattern for a lidar device according to one or more embodiments;

FIG. 5B depicts a block diagram of a custom lidar scan pattern for a lidar device according to one or more embodiments; and

FIG. 6 illustrates a block diagram of a processing system for impedance balancing for a monitoring circuit of a battery of a vehicle according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

One or more embodiments described herein relates to infrastructure access control using vehicle-based lidar.

Infrastructure access control refers to the systems, apparatuses, and processes used to regulate and manage the entry and exit of vehicles or individuals to and from secure or restricted areas. This involves the use of various technologies and methods, such as identification verification, automated gates, and security protocols, to ensure that authorized entities can access specific infrastructure objects like toll roads, border crossings, gated communities, and secure facilities, while restricting access to unauthorized entities. The goal of infrastructure access control is to enhance security, improve operational efficiency, and provide real-time monitoring and management of access points.

Modern infrastructure access control systems often rely on physical security objects (referred to as “infrastructure objects”), such as gates, toll booths, and border crossings to regulate vehicle entry. These systems typically require drivers to interact with physical devices, such as RFID tags, badges, or manual input systems, to gain access. This interaction can be cumbersome and time-consuming, particularly for drivers who face challenges leaving their vehicles or for fleet operations that require efficient and secure access control.

Existing solutions for infrastructure access control present several disadvantages. Physical security elements often involve manual intervention, which can lead to delays and inefficiencies, especially in high-traffic areas. Additionally, reliance on physical devices, such as RFID tags or badges, introduces the risk of loss, theft, or damage, compromising security. Furthermore, these systems may not provide real-time monitoring and verification of driver identity, leading to potential unauthorized access and security breaches.

One or more embodiments described herein addresses these and other issues by utilizing advancements in lidar technology to enable real-time, customized scan patterns for infrastructure access control. One or more embodiments dynamically customizes and deploys custom lidar scan patterns. This approach enhances security and accessibility by allowing vehicles to be identified through customizable scan patterns observed by a receiver associated with an infrastructure object, such as a gate and or toll road. One or more embodiments provides continuous fleet monitoring and logistics management, ensuring secure and efficient access to infrastructure without requiring additional physical devices.

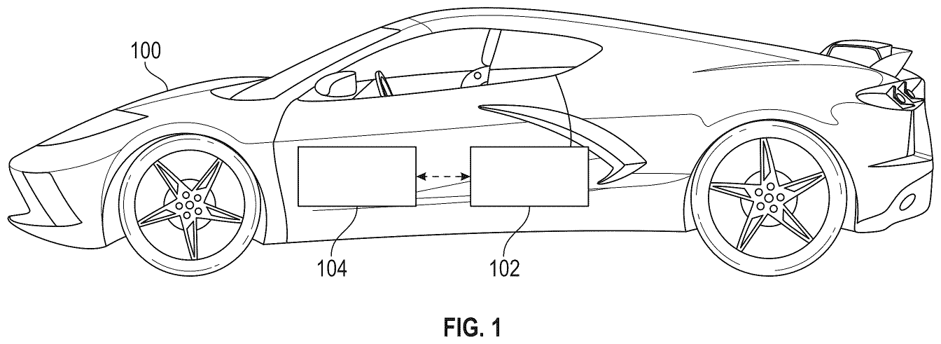

FIG. 1 shows a vehicle 100 with a processing system 102 and sensors 104 according to one or more embodiments. The vehicle 100 can be a car, a truck, a van, a bus, a motorcycle, a boat, or any other type of automobile. According to an embodiment, the vehicle 100 is a hybrid electric vehicle, such as a plug-in hybrid electric vehicle (PHEV) partially or wholly powered by electrical power. According to another embodiment, the vehicle 100 is an electric vehicle powered by electrical power. A battery is used to provide electrical power to components of the vehicle 100, such as an electric motor (not shown), electrical components (not shown), and/or the like, including combinations and/or multiples thereof. According to one or more embodiments, the vehicle 100 is an autonomous or semi-autonomous vehicle. An autonomous vehicle is a vehicle that has self-driving capabilities. A semi-autonomous vehicle is a vehicle that has certain autonomous features (e.g., self-parking, lane keeping, etc.) but lacks full autonomous control.

The processing system 102 is located within the vehicle and is responsible for managing and processing data collected by the sensors 104. The sensors 104 are strategically positioned on the vehicle to gather various types of data from the vehicle's environment. The arrows between the sensors 104 and the processing system 102 indicate the flow of data from the sensors 104 to the processing system 102, highlighting the interaction between these components. This setup enables the vehicle 100 to perform tasks related to infrastructure access control, such as detecting infrastructure objects and emitting custom lidar scan patterns. Examples of the sensors 104 include, but are not limited to, a lidar device, a camera device, a global positioning system (GPS) device, a driver monitoring system (DMS) camera device, and/or the like, including combinations and/or multiples thereof.

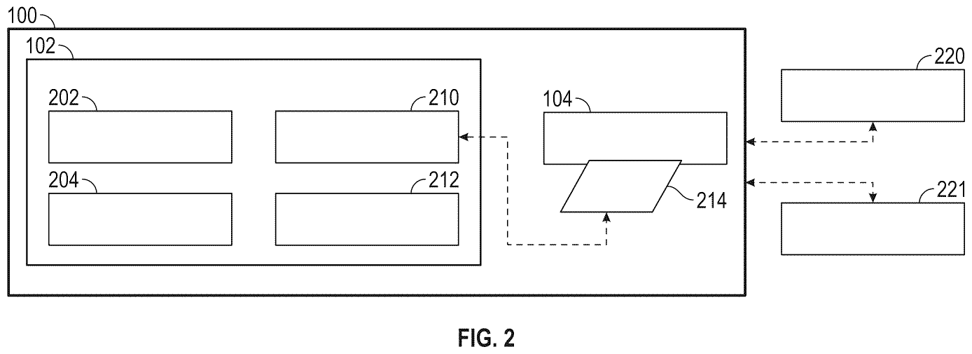

Further features of the processing system 102 and the sensors 104 are now described with reference to FIGS. 2-5B.

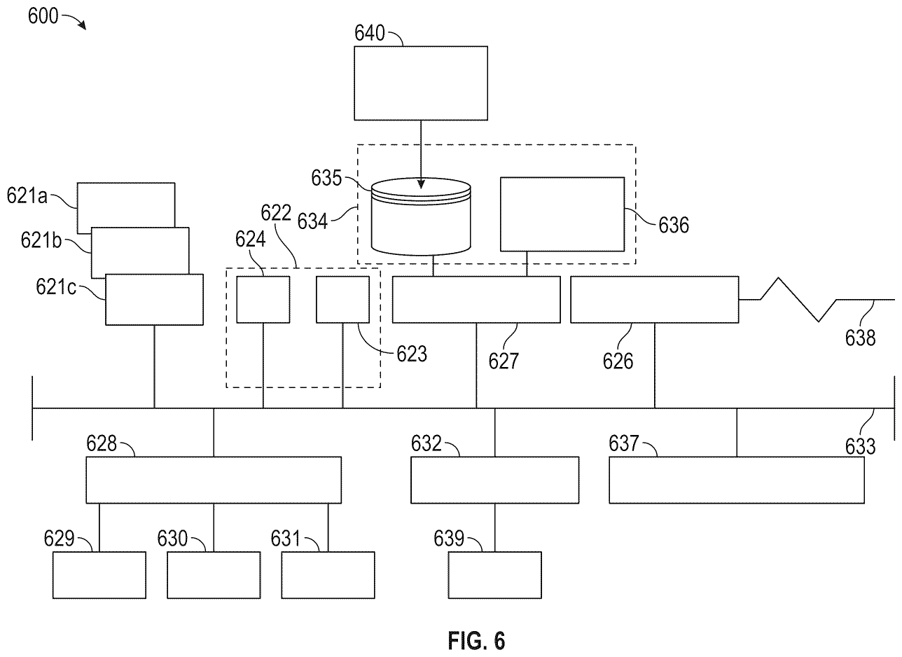

Particularly, FIG. 2 illustrates the processing system of FIG. 1 according to one or more embodiments. According to one or more embodiments, the processing system 102 includes a processing device 202, a memory 204, a scan pattern engine 210, and an autonomous driving engine 212. It should be appreciated that the processing system 102 can be any device suitable for performing or supporting infrastructure access control using vehicle-based lidar. For example, the processing system 102 can be a device implemented in or otherwise associated with the vehicle 100, such as an electronic control unit (also referred to as an electronic control module). As another example, the processing system 102 can be a smartphone, tablet computer, laptop computer, desktop computer, wearable computing device, and/or the like, including combinations and/or multiples thereof. As yet another example, the processing system 102 can be the processing system 600 of FIG. 6 and/or can include one or more components of the processing system 600 of FIG. 6.

The processing device 202 is responsible for executing instructions and managing the overall operation of the processing system 102. The processing device 202 can be any suitable processing circuitry for executing instructions and processing data. For example, the processing device 202 can be a microcontroller, microprocessor, application-specific integrated circuit (ASIC), or any other type of processing unit capable of handling the computational demands of the processing system 102. The processing device 202 is an example of one or more of the processing devices 621 of FIG. 6, as described in more detail herein.

The memory 204 stores data (e.g., sensor data 214), computer-readable instructions, and algorithms useful for operation of the processing system 102. This may include real-time data processing, historical data analysis, and storage of firmware or software programs. The memory 204 is any suitable device for storing data, such as the sensor data 214, and/or instructions. For example, the memory 204 can be a combination of volatile memory (e.g., random access memory) and non-volatile memory (e.g., read-only memory, flash memory). The memory 204 is an example of one or more of the system memory 622, the random access memory 623, and/or the read-only memory 624 of FIG. 6, as described in more detail herein.

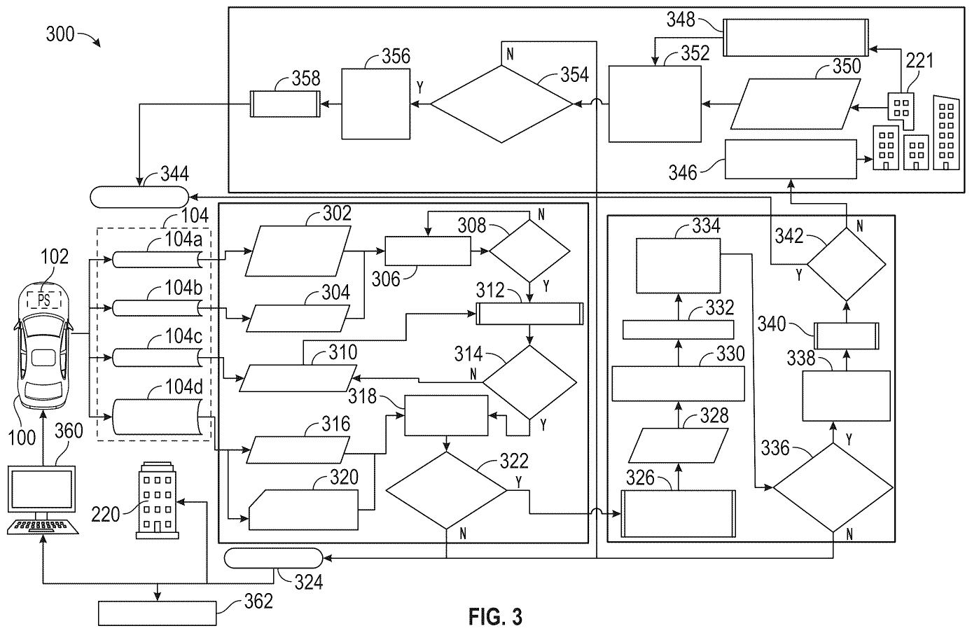

The scan pattern engine 210 is a specialized component that generates and manages custom lidar scan patterns used for infrastructure access control. For example, the scan pattern engine 210 processes sensor data 214 from a lidar device (e.g., the lidar device 104a of FIG. 3) to create a point cloud of the environment in which the vehicle 100 is operating using a standard lidar scan pattern. The scan pattern engine 210 then normalizes the standard lidar scan pattern based on the location of the vehicle 100 relative to an infrastructure object (e.g., a gate). The scan pattern engine 210 selects the appropriate custom lidar scan pattern from a plurality of predefined custom lidar scan patterns stored in the memory 204. These custom lidar scan patterns are tailored to specific infrastructure objects, such as particular gates or toll booths, and are designed to be recognized by receivers associated with those objects. By emitting these custom lidar scan patterns, the scan pattern engine 210 ensures that the infrastructure objects can accurately identify and respond to the vehicle 100, facilitating secure and efficient access control.

The autonomous driving engine 212 controls the autonomous navigation capabilities of the vehicle 100, allowing the vehicle to navigate with respect to detected infrastructure objects. Once the scan pattern engine 210 has successfully emitted a custom lidar scan pattern and the infrastructure object has implemented a desired action (e.g., opening a gate), the autonomous driving engine 212 causes the vehicle 100 to navigate with respect to the infrastructure object (e.g., drive through the open gate). The autonomous driving engine 212 processes sensor data 214 received from the sensors 104 (e.g., the lidar device, camera devices, and GPS device) to determine the precise location and orientation of the vehicle 100. The autonomous driving engine 212 then generates control signals to steer, accelerate, or brake the vehicle as needed to safely and efficiently navigate through the opened gate or other infrastructure object. The autonomous driving engine 212 ensures that the vehicle 100 can autonomously perform complex maneuvers, reducing the need for manual intervention and enhancing the overall efficiency of the access control process.

In the embodiment of FIG. 2, it is shown that the processing system 102 can communicate with a remote system 220 and an infrastructure object system 221. The remote system 220 can communicate with the vehicle's processing system to provide additional data or receive alerts, such as alerts to or from police or a fleet management system. The infrastructure object system 221 represents a system associated with an infrastructure object, such as a gate or toll booth, that interact with the vehicle 100. The dashed arrows indicate the flow of data and communication between these components, highlighting the interconnected nature of the system for effective infrastructure access control. The remote system 220 and the infrastructure object system 221 can be any suitable computing system(s) for collecting data, analyzing data, storing data, communicating with other systems (such as the processing system 102), and/or the like, including combinations and/or multiples thereof.

FIG. 3 illustrates a flow diagram of a method 300 for infrastructure access control using vehicle-based lidar according to one or more embodiments. The method 300 can be implemented using any suitable system or device. For example, the method 300, and its steps, can be implemented using the processing system 102 of FIGS. 1 and 2, by the processing system 600 of FIG. 6, and/or the like, including combinations and/or multiples thereof. The method 300 is now described with reference to FIGS. 1 and 2 but is not so limited.

The vehicle 100 collects data using the sensors 104. For example, the vehicle 100 can be equipped with various sensors 104, such as a lidar device 104a, a camera device 104b, a GPS device 104c, and a driver monitoring system (DMS) camera device 104d. The sensors 104 collect data from the vehicle's environment and provide the data to the processing system 102. Particularly, the method 300 starts at block 302, where the lidar device 104a acquires a point cloud of the environment. At block 304, the camera device 104b acquires an image of the environment. The data from these two sensors is used at block 306 to detect the presence of an infrastructure object, such as a gate. If no infrastructure object is detected (block 308, “No”), the method 300 returns to block 306 to continue attempting to detect an infrastructure object using the data collected at blocks 302 and 304. If an infrastructure object is detected (block 308, “Yes”), the method 300 moves to block 312, where the processing system 102 checks if the GPS location of the vehicle 100 substantially matches a known location for a known infrastructure object. The GPS location of the vehicle 100 is acquired at block 310, where the GPS device 104c acquires the vehicle's location (e.g., GPS coordinates for the vehicle).

If the location does not match (block 314, “No”), the method 300 returns to block 310 to re-acquire the location. If the location matches (block 314, “Yes”), the DMS camera device 104d acquires an image of the driver at block 316. The processing system 102 then performs driver authentication at block 318 by verifying the image against pre-authorized identities stored at block 320. If the driver's identity is not confirmed (block 322, “No”), an alert is generated at block 324. The alert can be sent to a remote system 220, a fleet manager 360, and/or law enforcement 362.

If the driver's identity is confirmed (block 322, “Yes”), the scan pattern engine 210 alerts the lidar device 104a to begin scanning the environment at block 326. The lidar device 104a acquires a point cloud of the infrastructure object using a standard lidar scan pattern at block 328. A standard lidar scan pattern refers to a predefined and consistent sequence of laser pulses emitted by the lidar device 104a to map the surrounding environment. This pattern typically involves the lidar device 104a rotating or oscillating to cover a particular field of view, emitting laser pulses at regular intervals and angles. The returning laser pulses are measured to create a point cloud, which is a three-dimensional representation of the environment. The standard lidar scan pattern is designed to provide a comprehensive and uniform coverage of the area around the vehicle 100, allowing for the detection and identification of objects, obstacles, and infrastructure objects.

At block 330, the scan pattern engine 210 normalizes the standard lidar scan pattern based on a location of the vehicle (determined at block 310) relative to a location of the infrastructure object, which is known. For example, different vehicles may approach the same infrastructure object differently (e.g., a first vehicle may stop a distance from a gate while a second vehicle may stop a different distance from the gate relative to the first vehicle, the same vehicle may approach the gate from slightly different angles at different times, and/or the like, including combinations and/or multiples thereof). This variation causes differences in point clouds captured at block 326. Accordingly, the scan pattern engine 210 normalizes the standard lidar scan pattern by accounting for variations in location of the vehicle 100 relative to the infrastructure object.

At block 332, the scan pattern engine 210 selects a custom lidar scan pattern from a plurality of custom patterns based on the detected infrastructure object. A custom lidar scan pattern refers to a tailored sequence of laser pulses emitted by a lidar device, which are specifically designed to identify the source of the custom lidar scan pattern. Unlike a standard lidar scan pattern, which provides uniform coverage of the environment, a custom scan pattern is optimized for identifying the source of the custom lidar scan pattern (e.g., the vehicle 100). This customization can involve altering the frequency, intensity, angle, or sequence of the laser pulses to create a unique pattern that can be recognized by a receiver on an infrastructure object, such as a gate or toll booth. According to one or more embodiments, the custom lidar scan pattern is selected from a plurality of predefined patterns stored in the system's memory, based on the type and characteristics of the detected infrastructure object. By using a custom lidar scan pattern, accurate identification and interaction with the infrastructure are provided, enabling actions, such as opening gates or granting access, thereby enhancing security and efficiency in access control processes.

At block 334, the scan pattern engine 210 triggers the lidar device 104a to emit the custom lidar scan pattern. It is then determined at block 336, such as by a system or device associated with the infrastructure object, whether the custom lidar scan pattern matches an expected lidar scan pattern associated with the infrastructure object. If the custom lidar scan patterns do not match (block 336, “No”), an alert is generated at block 324. If the custom lidar scan patterns matches (block 336, “Yes”), the infrastructure object is triggered to implement an action, such as opening a gate, at block 338. The action is logged at block 340.

At block 342, the processing system 102 checks if the infrastructure action was completed successfully. If the action was successful (block 342, “Yes”), the autonomous driving engine 212 causes the vehicle 100 to be autonomously controlled to navigate (e.g., to drive through the opened gate) at block 344. If the action was not successful (block 342, “No”), the infrastructure object system 221 is initiated to perform a secondary authentication using the custom lidar scan pattern. Particularly, the infrastructure object system 221 triggers an infrastructure camera(s) at block 346, and an image is acquired using one or more infrastructure cameras associated with the infrastructure object at block 350 while the custom lidar scan pattern is emitted at block 348. For example, the LiDAR device emits a low voltage scan pattern at block 348, which represents the custom lidar scan pattern, and an infrastructure camera acquires image(s) at block 350 to capture the emitted custom lidar scan pattern from the vehicle 100.

At block 352, the infrastructure device system 211 verifies whether a luminance changes in the acquired image(s) match the expected changes based on the custom lidar scan pattern. If the luminance does not match (e.g., is not within a threshold amount of luminance) (block 354, “No”), an alert is generated at block 324. If the luminance matches (block 354, “Yes”), the infrastructure object is triggered to perform the action at block 356 (e.g., to open the gate), and the entry is logged at block 358. The autonomous driving engine 212 causes the vehicle 100 to be autonomously controlled to navigate (e.g., to drive through the opened gate) at block 344.

Additional processes also may be included, and it should be understood that the processes depicted in FIG. 3 represent illustrations, and that other processes may be added, or existing processes may be removed, modified, or rearranged without departing from the scope of the present disclosure. It should also be understood that the processes depicted in FIG. 3 may be implemented as programmatic instructions stored on a non-transitory computer-readable storage medium that, when executed by a processor (e.g., the processing device 202 of FIG. 2, the processor(s) 621 of FIG. 6, and/or the like, including combinations and/or multiples thereof) of a computing system (e.g., the processing system 102 of FIGS. 1 and 2, the processing system 600 of FIG. 6, and/or the like, including combinations and/or multiples thereof), cause the processor to perform the processes described herein.

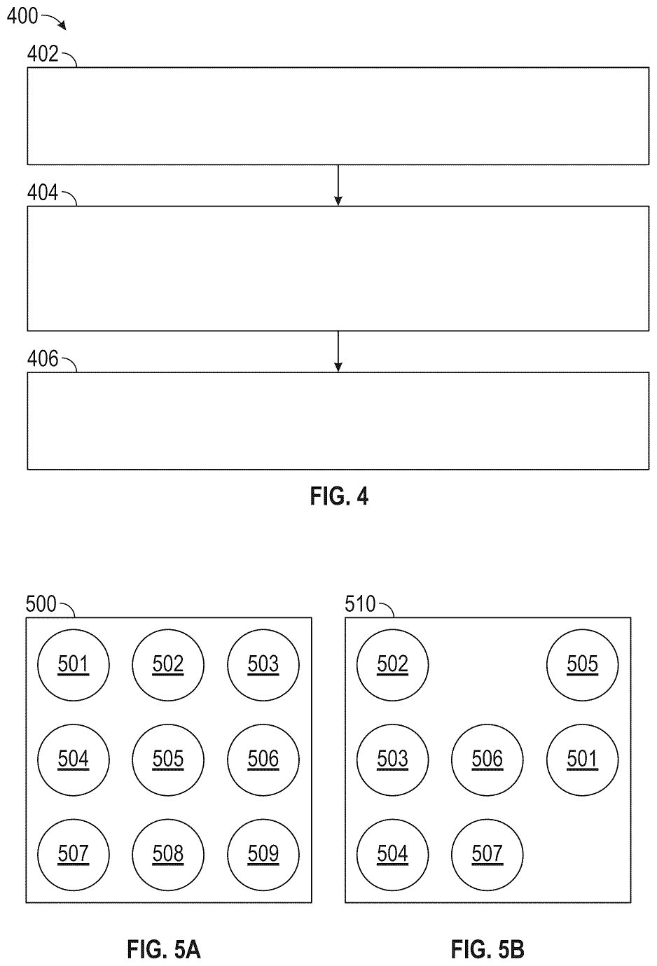

FIG. 4 illustrates a flow diagram of a method 400 for infrastructure access control using vehicle-based lidar according to one or more embodiments. The method 400 can be implemented using any suitable system or device. For example, the method 400, and its steps, can be implemented using the processing system 102 of FIGS. 1 and 2, by the processing system 600 of FIG. 6, and/or the like, including combinations and/or multiples thereof. The method 400 is now described with reference to FIGS. 1-3 but is not so limited.

At block 402, the processing system 102 detects an infrastructure object in the environment in which the vehicle 100 is operating. This detection is based at least in part on data collected by the sensors 104. For example, the lidar device 104a can collect lidar data (e.g., sensor data 214) about the environment in which the vehicle 100 is operating, including the infrastructure object. The lidar device scans the environment surrounding the vehicle 100 and identifies infrastructure objects that may be relevant for access control, such as gates, toll booths, or other infrastructure objects. The detection process involves analyzing point cloud data generated by the lidar device 104a to recognize the presence and characteristics of the infrastructure object.

At block 404, the processing system 102, using the scan pattern engine 210 and the lidar device 104a, emits a custom lidar scan pattern associated with the detected infrastructure object. This custom lidar scan pattern is specifically designed to be recognized by a receiver on the infrastructure object. According to one or more embodiments, the custom lidar scan pattern is unique to the vehicle 100 and to the infrastructure object. The custom lidar scan pattern is selected from a plurality of predefined patterns based on the identified infrastructure object. The infrastructure device can be identified by location, type, and characteristics of the detected infrastructure object. When the receiver on the infrastructure object detects the custom lidar scan pattern, the infrastructure object is caused to implement a specific action, such as opening a gate or allowing access through a toll booth.

At block 406, responsive to the infrastructure object implementing the action, the processing system 102, using the autonomous driving engine 212, autonomously controls the vehicle 100 to navigate with respect to the infrastructure object. This involves generating control signals to steer, accelerate, or brake the vehicle 100 as appropriate to efficiently navigate the vehicle 100 through the opened gate or other infrastructure object. The autonomous control ensures that the vehicle 100 can seamlessly and efficiently navigate the infrastructure object without manual intervention from the driver of the vehicle 100 and/or other personnel, enhancing the overall efficiency and security of the access control process.

Additional processes also may be included, and it should be understood that the processes depicted in FIG. 4 represent illustrations, and that other processes may be added, or existing processes may be removed, modified, or rearranged without departing from the scope of the present disclosure. It should also be understood that the processes depicted in FIG. 4 may be implemented as programmatic instructions stored on a non-transitory computer-readable storage medium that, when executed by a processor (e.g., the processing device 202 of FIG. 2, the processor(s) 621 of FIG. 6, and/or the like, including combinations and/or multiples thereof) of a computing system (e.g., the processing system 102 of FIGS. 1 and 2, the processing system 600 of FIG. 6, and/or the like, including combinations and/or multiples thereof), cause the processor to perform the processes described herein.

FIG. 5A depicts a block diagram of a standard lidar scan pattern 500 for a lidar device (e.g., the lidar device 104a) according to one or more embodiments. FIG. 5B depicts a block diagram of a custom lidar scan pattern 510 for a lidar device (e.g., the lidar device 104a) according to one or more embodiments. In these examples, each point 501, 502, 503, 504, 505, 506, 507, 508, 509 represents a point that is captured as part of a lidar scan by the lidar device 104a. For the standard lidar scan pattern 500, the scan is performed using a predefined and consistent sequence of laser pulses (represented by the points 501-509) emitted by the lidar device 104a to map the surrounding environment. For example, the lidar device 104a may first emit a laser point at point 501, then at point 502, then at point 503, and so forth continuing until point 509. In such an example, each of the pulses may be performed using the same parameters (e.g., substantially the same amount of time, at substantially the same frequency, and/or the like, including combinations and/or multiples thereof). However, in the case of the custom lidar scan pattern 510, the sequence and properties of the scan performed by the lidar device 104a differs from the standard lidar scan pattern 500. For example, in FIG. 5B, the lidar device 104a scans the points 501-507 in the order shown. It should further be appreciated that the lidar device 104a can vary properties of the lidar scan at each point. For example, the amount of time of laser pulses, the frequency of the laser pulses, and/or the like, including combinations and/or multiples thereof, can be varied from point-to-point. Given the extensive number of points performed in a lidar scan (e.g., hundreds of thousands or even millions of points), and the opportunity to vary parameters with each point, the number of possibilities of custom lidar scan patterns is vast and may enable custom scan patterns to be unique (e.g., unique to a user, a vehicle, and an infrastructure object). It should be appreciated that the standard lidar scan pattern 500 (FIG. 5A) and the custom lidar scan pattern 510 (FIG. 5B) are merely simplified examples and that many different arrangements of standard and custom lidar scan patterns are possible.

It is understood that one or more embodiments described herein is capable of being implemented in conjunction with any other type of computing environment now known or later developed. For example, FIG. 6 depicts a block diagram of a processing system 600 for implementing the techniques described herein. In accordance with one or more embodiments described herein, the processing system 600 is an example of a cloud computing node of a cloud computing environment. In examples, processing system 600 has one or more central processing units (referred to also as “processors” or “processing resources” or “processing devices”) 621a, 621b, 621c, etc. (collectively or generically referred to as processor(s) 621 and/or as processing device(s) 621). In aspects of the present disclosure, each processor 621 can include a reduced instruction set computer (RISC) microprocessor. Processors 621 are coupled to a system memory 622 and/or various other components via a system bus 633. The system memory 622 can include one or more temporary and/or persistent memory devices, such as a random access memory (RAM) 623, a read-only memory (ROM) 624, and/or the like, including combinations and/or multiples thereof. The system bus 633 may include a basic input/output system (BIOS), which controls certain basic functions of processing system 600.

Further depicted are an input/output (I/O) adapter 627 and a network adapter 626 coupled to system bus 633. I/O adapter 627 may be a small computer system interface (SCSI) adapter that communicates with a hard disk 635 and/or a storage device 636 or any other similar component. I/O adapter 627, hard disk 635, and storage device 636 are collectively referred to herein as mass storage 634. Operating system 640 for execution on processing system 600 may be stored in mass storage 634. The network adapter 626 interconnects system bus 633 with an outside network 638 enabling processing system 600 to communicate with other such systems.

A display (e.g., a display monitor) 639 is connected to system bus 633 by display adapter 632, which may include a graphics adapter to improve the performance of graphics intensive applications and a video controller. In one aspect of the present disclosure, adapters 626, 627, and/or 632 may be connected to one or more I/O buses that are connected to system bus 633 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 633 via user interface adapter 628 and display adapter 632. A keyboard 629, mouse 630, and speaker 631 may be interconnected to system bus 633 via user interface adapter 628, which may include, for example, a Super I/O chip integrating multiple device adapters into a single integrated circuit.

In some aspects of the present disclosure, processing system 600 includes a graphics processing unit (GPU) 637. Graphics processing unit 637 is a specialized electronic circuit designed to manipulate and alter memory to accelerate the creation of images in a frame buffer intended for output to a display. In general, graphics processing unit 637 is very efficient at manipulating computer graphics and image processing and has a highly parallel structure that makes it more effective than general-purpose CPUs for algorithms where processing of large blocks of data is done in parallel.

Thus, as configured herein, processing system 600 includes processing capability in the form of processors 621, storage capability including the system memory 622 and mass storage 634, input means such as keyboard 625 and mouse 630, and output capability including speaker 631 and display 639. In some aspects of the present disclosure, a portion of system memory 622 and mass storage 634 collectively store the operating system 640 to coordinate the functions of the various components shown in processing system 600.

One or more embodiments offer several significant benefits and advantages over existing approaches to infrastructure access control, including (but not limited to) the following.

Secure entry is granted to vehicles through customized lidar scan patterns, eliminating the need for additional hardware, such as RFID transmitters or badges. This reduces the risk of loss, theft, or damage to physical security devices.

One or more embodiments provide robust protection against unauthorized entry to secure locations by verifying the driver's identity using existing vehicle hardware, such as a DMS. This ensures that only authorized drivers can access secure areas.

One or more embodiments mitigate subjective decisions by security personnel and reduce gate congestion by automating the access control process. This leads to faster and more efficient entry for authorized vehicles.

One or more embodiments enable Vehicle-to-Infrastructure (V2X) logistics management through continuous monitoring of infrastructure object, such as gates, booths, and infrastructure objects, along a route. This ensures real-time tracking and management of vehicles, including fleet operations for example.

One or more embodiments increase accessibility for users who require additional assistance when encountering an infrastructure object, such as a gate. By automating the access control process, the need for drivers to exit their vehicles to interact with physical security elements is reduced.

One or more embodiments dynamically customize and deploy lidar scan patterns based on the specific infrastructure object, enhancing the flexibility and adaptability of the access control process.

Once access is granted, one or more embodiments can autonomously control the vehicle to navigate with respect to the infrastructure object, further streamlining the entry process and reducing the need for manual intervention.

In case of unauthorized access attempts or failures in the access control process, one or more embodiments can generate real-time alerts and report to third parties, such as remote systems, fleet managers, or law enforcement, ensuring prompt response to security breaches.

These and other benefits may be possible in various embodiments as described herein.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A computer-implemented method for infrastructure access control using vehicle-based lidar, the method comprising:
detecting an infrastructure object in an environment in which a vehicle is operating based at least in part on lidar data collected by a lidar device of the vehicle;
emitting a custom lidar scan pattern associated with the infrastructure object, the custom lidar scan pattern being received by a receiver of the infrastructure object and causing the infrastructure object to implement an action; and
responsive to the infrastructure object implementing the action, autonomously controlling the vehicle to cause the vehicle to navigate with respect to the infrastructure object.

2. The computer-implemented method of claim 1, wherein the infrastructure object is an access gate, and wherein the action is opening the access gate.

3. The computer-implemented method of claim 1, further comprising, subsequent to emitting the custom lidar scan pattern associated with the infrastructure object and prior to autonomously controlling the vehicle, determining whether the infrastructure object implemented the action successfully.

4. The computer-implemented method of claim 3, wherein autonomously controlling the vehicle is performed responsive to determining that the infrastructure object implemented the action successfully.

5. The computer-implemented method of claim 3, further comprising, responsive to determining that the infrastructure object failed to implement the action successfully:
initiating a remote system to acquire an image of the infrastructure object while the custom lidar scan pattern is emitted;
receiving the image of the infrastructure object from the remote system;
verifying a luminance change in the image of the infrastructure object matches an expected luminance change based on the custom lidar scan pattern with the infrastructure object; and
responsive to verifying that the luminance change in the image of the infrastructure object matches the expected luminance change, causing, by the remote system, the infrastructure object to implement the action.

6. The computer-implemented method of claim 1, wherein emitting the custom lidar scan pattern associated with the infrastructure object comprises:
acquiring, by the lidar device, a point cloud of the infrastructure object, using a standard lidar scan pattern;
normalizing the standard lidar scan pattern based on a location of the vehicle relative to a location of the infrastructure object;
selecting the custom lidar scan pattern from a plurality of custom lidar scan patterns based on the infrastructure object; and
causing the lidar device to emit the custom lidar scan pattern.

7. The computer-implemented method of claim 1, wherein the custom lidar scan pattern causes the infrastructure object to implement the action responsive to the custom lidar scan pattern matching an expected custom lidar scan pattern.

8. The computer-implemented method of claim 1, wherein the custom lidar scan pattern is defined by a custom frequency.

9. The computer-implemented method of claim 1, wherein the custom lidar scan pattern is defined by a custom sequence of lidar pulses.

10. A vehicle comprising:
a driver monitoring system comprising a camera;
a lidar device; and
a processing system for infrastructure access control using vehicle-based lidar, the processing system comprising:
a memory comprising computer readable instructions; and
a processing device for executing the computer readable instructions, the computer readable instructions controlling the processing system to perform operations comprising:
detecting an infrastructure object in an environment in which the vehicle is operating based at least in part on lidar data collected by the lidar device of the vehicle;
determining, using an image of an operator of the vehicle captured by the camera, whether the operator of the vehicle is an authorized operator of the vehicle;
responsive to determining that the operator of the vehicle is the authorized operator of the vehicle, emitting a custom lidar scan pattern associated with the infrastructure object, the custom lidar scan pattern being received by a receiver of the infrastructure object and causing the infrastructure object to implement an action; and
responsive to the infrastructure object implementing the action, autonomously controlling the vehicle to cause the vehicle to navigate with respect to the infrastructure object.

11. The vehicle of claim 10, wherein the camera is a first camera, the vehicle further comprising a second camera.

12. The vehicle of claim 10, further comprising a global positioning system (GPS) device, the operations further comprising determining a location of the infrastructure object based at least in part on information received from the GPS device.

13. The vehicle of claim 12, wherein the custom lidar scan pattern associated with the infrastructure object is emitted based at least in part on the location of the infrastructure object.

14. The vehicle of claim 10, the operations further comprising, responsive to determining that the operator of the vehicle is not the authorized operator of the vehicle, generating an alert.

15. The vehicle of claim 10, wherein emitting the custom lidar scan pattern associated with the infrastructure object comprises:
acquiring, by the lidar device, a point cloud of the infrastructure object, using a standard lidar scan pattern;
normalizing the standard lidar scan pattern based on a location of the vehicle relative to a location of the infrastructure object;
selecting the custom lidar scan pattern from a plurality of custom lidar scan patterns based on the infrastructure object; and
causing the lidar device to emit the custom lidar scan pattern.

16. The vehicle of claim 10, wherein the operations further comprise, subsequent to emitting the custom lidar scan pattern associated with the infrastructure object and prior to autonomously controlling the vehicle, determining whether the infrastructure object implemented the action successfully.

17. The vehicle of claim 16, wherein autonomously controlling the vehicle is performed responsive to determining that the infrastructure object implemented the action successfully.

18. The vehicle of claim 16, wherein the operations further comprise, responsive to determining that the infrastructure object failed to implement the action successfully:
initiating a remote system to acquire an image of the infrastructure object while the custom lidar scan pattern is emitted;
receiving the image of the infrastructure object from the remote system;
verifying a luminance change in the image of the infrastructure object matches an expected luminance change based on the custom lidar scan pattern with the infrastructure object; and
responsive to verifying that the luminance change in the image of the infrastructure object matches the expected luminance change, causing, by the remote system, the infrastructure object to implement the action.

19. A computer program product comprising:
a set of one or more computer-readable storage media;
program instructions, collectively stored in the set of one or more storage media, for causing a processor set to perform computer operations for infrastructure access control using vehicle-based lidar, the computer operations comprising:
detecting an infrastructure object in an environment in which a vehicle is operating based at least in part on lidar data collected by a lidar device of the vehicle;
emitting a custom lidar scan pattern associated with the infrastructure object, the custom lidar scan pattern being received by a receiver of the infrastructure object and causing the infrastructure object to implement an action; and
responsive to the infrastructure object implementing the action, autonomously controlling the vehicle to cause the vehicle to navigate with respect to the infrastructure object.

20. The computer program product of claim 19, wherein emitting the custom lidar scan pattern associated with the infrastructure object comprises:
acquiring, by the lidar device, a point cloud of the infrastructure object, using a standard lidar scan pattern;
normalizing the standard lidar scan pattern based on a location of the vehicle relative to a location of the infrastructure object;
selecting the custom lidar scan pattern from a plurality of custom lidar scan patterns based on the infrastructure object; and
causing the lidar device to emit the custom lidar scan pattern.
